(19) United States
(12) Patent Application Publication
(10) Pub. No.: US 2011/0032788 A1
(43) Pub. Date: Feb. 10, 2011

(54) LIQUID MIXING CHAMBER

(76) Inventor: Paulus Antonius Augustinus Hofte, Astene (BE)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/846,948

(22) Filed: Jul. 30, 2010

(30) Foreign Application Priority Data
Aug. 5, 2009 (EP) 09167224.6

(51) Int. Cl. B01F 15/02

(52) U.S. Cl. 366/130; 366/181.5

(57) ABSTRACT

An apparatus and method for mixing and dispensing liquids without contamination of starting liquids during the dispensing operation, the apparatus comprising a first container, resiliently deformable, containing a first liquid, a second container containing a second liquid, and a mixing chamber.

### FIELD OF THE INVENTION

The present invention relates to an apparatus and method for dispensing liquids and/or mixtures of liquids without contamination of starting liquids during the dispensing operation.

### BACKGROUND TO THE INVENTION

There exist apparatuses that allow late stage, in-the-home customization of liquid products by the consumer. Customization usually involves the addition of one or more optional ingredients to a base composition resulting in a product optimized for the particular preference of each consumer.

EP1760142A1 discloses a number of ways of achieving late stage scent customization of laundry products. Many of these involve the consumer mixing at least two liquids in a receptacle prior to the resultant mixture being used in the intended application, such as a laundry machine. Thus, the consumer requires at least three separate articles in order to achieve the customization; the first liquid in a container, the second liquid in a container and the mixing receptacle. There are then a number of steps required to be completed by the consumer; addition of the first liquid to the mixing receptacle, addition of the second liquid to the mixing receptacle and dispensing of the resultant mixture from the mixing receptacle to the end use application. This process is time consuming and requires for efficient use, the consumer to store the three separate articles together which is space consuming.

A preferred method of mixing the two liquids is also disclosed in EP1760142A1. A bottle is provided comprising a chamber in which there is a neutral scented base liquid laundry detergent composition. Integrated into the bottle is a dosing chamber which the neutral scented base liquid laundry detergent composition can flow through upon dispensing the liquid during pouring. A scent disc can also be connected to the dosing chamber. The consumer can then dose a volume of the scent disc liquid into the dosing chamber. Then upon pouring, the neutral scented base liquid laundry detergent composition flows through the dosing chamber, mixing with the scent liquid before it is dispensed out of the bottle. This then has the benefit of allowing the consumer to store the apparatus as a single unit, and also involves a much simpler mixing and dispensing process.

However, there are problems with this apparatus. A first issue is that the mixing requires a pouring operation. This is not very efficient for liquids having high rheological characteristics. Such liquids, for example shampoos are squeezed out of the bottle by the user. Another problem is that once the mixture has been dispensed out of the bottle, there is a tendency for a small volume to remain in the dosing chamber. There is then a risk that this small volume can contaminate the neutral scented base liquid laundry detergent composition as the bottle is returned to an upright position following dispensing, due to the neutral scented base liquid laundry detergent composition flowing back from the dosing chamber into the neutral scented base liquid laundry detergent composition storage chamber. A second issue is that the dosing chamber is integrated into the bottle. Therefore, there is not the option to change/renew the neutral scented base liquid laundry detergent composition, only the scent disc. Therefore, in order to change/renew the neutral scented base liquid laundry detergent composition, a new dosing chamber must also be supplied. This is cost inefficient and environmentally unsound as the old dosing chamber will be thrown out.

Therefore, in the context of consumer in-the-house customization, there exists in the art the need for an apparatus for mixing at least two starting liquids prior to dispensing of the resultant mixture via squeezing of the apparatus by the user, which does not suffer from contamination of the starting liquids during the dispensing process. There is also a need that the starting liquids are preferably changeable and renewable.

The present invention provides an apparatus for mixing at least two liquids comprising a mixing chamber which comprises a one-way valve. The one-way valve prevents the contamination of the starting liquids during the dispensing process. It also allows for the removable attachment of a squeezable container containing a liquid.

### SUMMARY OF THE INVENTION

A first aspect of the present invention is an apparatus 1 for mixing and dispensing liquids, comprising a first container 2, a second container 3 and a mixing chamber 4, wherein;

the mixing chamber 4 comprises walls and an outlet orifice 5;
wherein a first wall 15 of the mixing chamber 4 comprises a first inlet opening 6, a second wall 16 of the mixing chamber 4 positioned opposite the first wall 15 comprises a liquid deflection zone 17;
and the first wall forms the base of the mixing chamber 4;
and the mixing chamber 4 further comprises a second inlet opening 7;
the first container 2 is resiliently deformable, contains a first liquid 8, and also a first container opening 9, the first container opening 9 communicating with the first inlet opening 6 of the mixing chamber 4;
and the first inlet opening 6 of the mixing chamber comprises a first one-way valve 10;
the second container 3 contains a second liquid 11, and a second container opening 12 which communicates with the second inlet opening 7 of the mixing chamber 4;
and wherein the second container opening 12 comprises a second one-way valve 13;
and wherein, the liquid deflection zone 17 is positioned directly opposite the first inlet opening 6.

A second aspect of the present invention is a method for mixing and dispensing a first liquid 8 and a second liquid 11 from the apparatus 1 comprising the steps of;
Dispensing a second liquid 11 from the second container 3 through the second inlet opening 7, into the mixing chamber 4;
Tilting the apparatus 1 at an angle such that the first liquid 8 flows from the first container 2 into the first container opening 9;
Squeezing the first container 2 such that the first liquid 8 is squeezed through the first one-way valve 10 into the mixing chamber 4 wherein the first liquid 8 mixes with the second liquid 11 in the mixing chamber 4;
Continuing to squeeze the first container 2, and maintaining the tilting angle such that, a desired volume of the first liquid 8 and/or the second liquid 11 is dispensed out of the outlet orifice 5;
Ceasing to squeeze the container 2 and also decreasing the tilting angle to prevent any further liquid from being dispensed from the apparatus 1;
Further decreasing the tilting angle to return the apparatus 1 to the resting position.

### BRIEF DESCRIPTION OF THE DRAWINGS

FIG. 1 details one embodiment of the apparatus of the present invention.

FIGS. 2A-B detail the mode of operation of the apparatus of the present invention.

FIGS. 3A-C detail one embodiment of the first one-way valve 10 of the present invention.

### DETAILED DESCRIPTION OF THE INVENTION

By “removably attached” we herein mean the container is attached in place but not necessarily in a permanent manner. It should be understood that it is the intention that the container is sufficiently secured in place such that a particular operation of the apparatus 1 may be achieved, but can be unattached from the apparatus 1 and replaced.

By the terms “a” and “an” when describing a particular element, we herein mean “at least one” of that particular element.

By “resiliently deformable”, we herein mean the container can be squeezed by the user such that the internal volume is decreased, but upon release, the container will return to its original shape and internal volume.

### The Apparatus

The apparatus 1 comprises a first container 2, a second container 3 and a mixing chamber 4. The first container 2 comprises a first container opening 9 and contains a first liquid 8, and the second container 3 comprises a second container opening 12 and contains a second liquid 11. Preferably, the apparatus 1 further comprises at least a third container comprising a third container opening and a fourth container comprising a fourth container opening

In one embodiment, the first container 2, the second container 3 and the mixing chamber 4 are manufactured as a single unit. In another embodiment, the mixing chamber 4 and the second container 3 are manufactured as a single unit. In this embodiment, the first container is manufactured separately and may be removably secured to the mixing chamber 4. In yet another embodiment, the mixing chamber 4 and the first container 2 are manufactured as a single unit, and the second container 3 is manufactured as a separate unit. In a final embodiment, the mixing chamber 4, the first container 3 and the second container 4 are all manufactured as separate units. The various units described can then be removably secured together or permanently secured together to make the apparatus 1.

The apparatus 1 can be made from any suitable thermoplastic polymer resin. Preferably, the thermoplastic polymer resin is selected from the group comprising polyethylene, polypropylene, polyethylene terephthalate, or copolymers thereof, and mixtures thereof.

The mixing chamber 4 comprises walls, an outlet orifice 5, and a first inlet orifice 6. The first inlet opening 6 comprises a one-way valve 10. The one-way valve 10 is designed to prevent any liquid present in the mixing chamber 4 from flowing back into the first container 2. A first wall of the mixing chamber 4 comprises a first inlet opening 6, and the first wall or another wall of the mixing chamber 4 comprises a second inlet opening 7. The first wall forms the base of the mixing chamber 4, and the first inlet opening 6 communicates with the first container opening 9. Thus, the first liquid 8 can only enter the mixing chamber 4 when the apparatus 1 is tilted so that the first liquid 8 can flow under gravity into the mixing chamber 4. The second container opening 12 communicates with the second inlet opening 7 of the mixing chamber 4. The outlet orifice 5 is positioned so that it is preferably not positioned directly opposite the first inlet opening 6. This is so that upon tilting and squeezing 19 of the apparatus 1, the first liquid 8 is forced through the first one-way valve 10 and into the mixing reservoir 4, wherein it is deflected off the liquid deflection zone 17. This deflection causes a turbulent effect 18 within the liquid resulting in mixing of the first liquid 8 and the second liquid 11. Therefore, preferably, the outlet orifice 5 is positioned so that it is not opposite the first inlet opening 6. In a preferred embodiment, there is a third inlet opening, more preferably a third and fourth inlet opening. The third container opening would communicate with the third inlet opening and the fourth container opening would communicate with the fourth inlet opening.

In one embodiment, the first one-way valve 10 is a duckbill valve. In another embodiment, the one-way valve 10 is selected from ball valve, slitseal valve or umbrella valve. In yet another embodiment, the one-way valve 10 is a combination valve allowing dispensing in one direction and venting of the bottle in the other direction. The valve could also be spring loaded, so that it only opens at a defined pressure. Most preferably the first one-way valve 10 is a duckbill valve and should be formed with a material having positional memory. Preferably, suitable materials for the manufacture of the first one-way valve 10 are selected from the group comprising polyethylene, polypropylene, polyoxymethylene plastic (available commercially as Delrin™), thermoplastic elastomer, liquid silicon rubber, thermoplastic urethane, acrylonitrile butadiene rubber, nytril rubber, natural rubber, ethylene propylene diene monomer rubber or similar materials or mixtures or copolymers of these materials. In one embodiment, the first one-way valve 10 is manufactured from a thermoplastic elastomer, preferably selected from the group comprising styrenic block copolymers, polyolefin blends, elastomeric alloys, thermoplastic polyurethanes, thermoplastic copolyester and thermoplastic polyamides or mixtures thereof. Preferred examples of commercially available thermoplastic elastomers include Santoprene™, poly(p-phenylene oxide), Elastolan™ and Hytrel™. In one embodiment, the first one-way valve 10 is manufactured from a material selected from the group comprising polyethylene, polypropylene or mixtures thereof. In one embodiment, the first one-way valve 10 is manufactured from polyethylene. In another embodiment, the first one-way valve 10 is manufactured from polypropylene. In another embodiment the first one one-way valve 10 is a hinged valve arrangement. In one embodiment, the first one-way valve 10 can be pushed outwards by the flow of the first liquid 8 when the first container 2 is squeezed. By “pushed outwards” we herein mean the first one-way valve 10 is deformed such that it decreases the internal volume of the mixing chamber 4, forcing any liquid in the mixing chamber 4 to be pushed out of the outlet orifice 5.

In another embodiment, the outlet orifice 5 further comprises a one-way valve. In one embodiment, the outlet one-way valve is a duckbill valve. In another embodiment, the one-way valve 10 is selected from ball valve, slitseal valve or umbrella valve. The one-way valve 10 could also be a flow restricting valve. In yet another embodiment, the one-way valve 10 is a combination valve allowing dispensing in one direction and venting of the bottle in the other direction. The valve could also be spring loaded, so that it only opens at a defined pressure. Most preferably the outlet one-way duckbill valve should be formed with a material having positional memory. Preferably, suitable materials for the manufacture of the outlet one-way duckbill valve are selected from the group comprising polyethylene, polypropylene, polyoxymethylene plastic (available commercially as Delrin™), thermoplastic elastomer, liquid silicon rubber, thermoplastic urethane, acrylonitrile butadiene rubber, nytril rubber, natural rubber, ethylene propylene diene monomer rubber or similar materials or mixtures or copolymers of these materials. In one embodiment, the outlet one-way duckbill valve is manufactured from a thermoplastic elastomer, preferably selected from the group comprising styrenic block copolymers, polyolefin blends, elastomeric alloys, thermoplastic polyurethanes, thermoplastic copolyester and thermoplastic polyamides or mixtures thereof. Preferred examples of commercially available thermoplastic elastomers include Santoprene™, poly(p-phenylene oxide), Elastolan™ and Hytrel™. Preferably, the outlet one-way duckbill valve is manufactured from a material selected from the group comprising polyethylene, polypropylene or mixtures thereof. In one embodiment, the outlet one-way duckbill valve is manufactured from polyethylene. In another embodiment, the outlet one-way duckbill valve is manufactured from polypropylene. In another embodiment the outlet one-way valve is a hinged valve arrangement.

The first liquid 8 can be any liquid. Preferably it is selected from the group comprising, cleaning composition, laundry detergent, fabric softening composition, fabric care composition, cosmetic composition, shampoo, hair conditioner composition, body cleansing composition, hard surface cleaner, bleaching composition and mixtures thereof. In a preferred embodiment, it is a hair conditioner composition. In a more preferred embodiment it is a neutrally scented hair conditioner composition.

The first container 2 can be of any shape, providing the first container opening 9 corresponds to the first inlet opening 6. Preferably, the first container opening 9 is removably secured to the first inlet opening 6 via a method selected from the group comprising screwing, clipping, clamping, gripping, snapping, pressure fitting and combinations thereof. Preferably, the method of removably securing the first container opening 9 to the first inlet opening 6 provides a liquid tight seal, so that no liquid can leak during the operation of the apparatus 1.

The second container 3 contains a second liquid 11, and a second container opening 12. The second container opening 12 communicates with the second inlet opening 7 of the mixing chamber 4. The second container opening 12 comprises a second one-way valve 13. Preferably, the second container can be removably secured to the apparatus 1 such that the second liquid can be dispensed into the mixing chamber 4 via the second inlet opening 7. The second container may or may not be squeezable.

In a more preferred embodiment, a third liquid is supplied in a third container, and a fourth liquid is supplied in fourth container. The third and fourth containers may or may not be squeezable. In this embodiment, the apparatus 1 comprises four inlet openings. Preferably, the third and fourth containers can be removably secured to the apparatus 1, such that the opening of the third container corresponds to the third inlet opening, the opening of the fourth container corresponds to the fourth inlet opening. In another embodiment, the second, third and fourth inlet openings each comprise a channel or spout to direct any liquid dispensed through the inlet channels into the mixing chamber 4. These three channels or spouts may or may not converge so as to form a single channel or spout for dispensing liquid into the at least one mixing chamber 4. In one embodiment, the mixing chamber 4 comprises sections, so that each of the second, third and fourth liquids are kept separate when dispensed into the mixing chamber 4. In another embodiment, the apparatus 1 comprises additional mixing chambers 4 such that each liquid is dispensed into a separate mixing chamber 4. The mixing chamber 4 can be of any suitable shape. Preferably, the shape is selected to encourage mixing of the liquids. In another embodiment, the mixing chamber 4 comprises baffles or other additions to encourage mixing of liquids.

The second container is preferably selected from the group comprising, bottle, cartridge, bag in bottle, delaminating bottles, delaminating cartridges, squeeze tubes, bag in tube, aerosol can, pouch, pouches with dispensing buttons, bellows, flexible bladder, dropper, pipette, capsule, sack, bag, disc, vessel, container, canister, blister, receptacle, holder, syringes or simple pump mechanisms using a piston to displace the product and other dosing systems known in the art and combinations thereof. The second container may be removably secured to the apparatus 1 using any suitable means, preferably selected from the group comprising screwing, clipping, clamping, gripping, snapping, pressure fitting and combinations thereof. Preferably, the second container comprises means to dispense a portion of the second liquid.

Preferably, the second container, is a cartridge comprising an inner chamber comprising a volume of an additional liquid, a button which upon being pressed will change shape and reduce the overall volume of the inner chamber, but upon release will return to its original shape, increasing the volume of the inner chamber to its original volume, a spring element and a one-way valve. In this embodiment, the apparatus 1 further comprises a cartridge mating member comprising a one-way valve engagement pin, a spring element interaction surface and an opening. The user presses the button. This action depresses the button and pushes the cartridge against the cartridge mating member. This compresses the spring element against the spring element interaction surface, which brings the one-way valve into contact with the one-way valve engagement pin, opening the one-way valve.

The second liquid contained in the second container can be dispensed from the second container to the second inlet opening 7 using any other suitable means, preferably selected from the group comprising, pumping, injecting, syringing, squeezing, spraying, pouring, dripping, capillary action and combinations thereof.

The second liquid can be any liquid. The term ‘liquid’ as used herein is not meant to be a limiting term and may encompass emulsions, dispersions, compositions, suspensions, pastes, gels and the like or mixtures thereof. The second liquid is preferably an additive suitable for use in the group comprising fabric care, hair care and body, detergents/cleaners, dish care and the like.

Preferably, the second liquid is selected from the group comprising perfume composition, encapsulated perfume composition, pro-perfume composition or combinations thereof. In a preferred embodiment, the second liquid is a perfume composition.

In one embodiment, the outlet orifice 5 comprises a spout, or channel. The spout or channel can be of any suitable length or shape as recognized by those skilled in the art.

In one embodiment, the outlet orifice 5 comprises a cap. In one embodiment, the cap has a hinged arrangement 14. In another embodiment, the cap is a twist-to-open or pull-to-open configuration. The cap can have any arrangement providing it blocks the orifice outlet 5 during shipping and storage of the device, but is removably secured so that the outlet orifice 5 is substantially free of obstructions that would block the flow of liquid from the mixing chamber 4 during the operation of the apparatus 1.

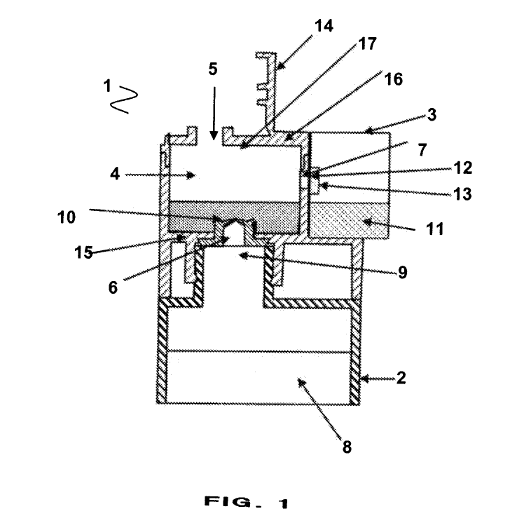

Looking at the figures in more detail; FIG. 1 details the apparatus 1 of the present invention. The apparatus 1 comprises the first container 2, the second container 3 and the mixing chamber 4. The mixing chamber 4 comprises walls and an outlet orifice 5. A first wall 15 of the mixing chamber 4 comprises the first inlet opening 6, and the second wall 16 is positioned opposite the first wall 15. The second wall 16 comprises the liquid deflection zone 17 which is positioned directly opposite the first inlet opening 6. The first wall forms the base of the mixing chamber 4. The mixing chamber 4 also comprises the second inlet opening 7. The first container 2 is resiliently deformable, contains the first liquid 8, and also the first container opening 9. The first container opening 9 communicates with the first inlet opening 6 of the mixing chamber 4; the first inlet opening 6 also comprises the first one-way valve 10. The second container 3 contains the second liquid 11, and the second container opening 12 which communicates with the second inlet opening 7 of the mixing chamber 4. The second container opening 12 also comprises a second one-way valve 13.

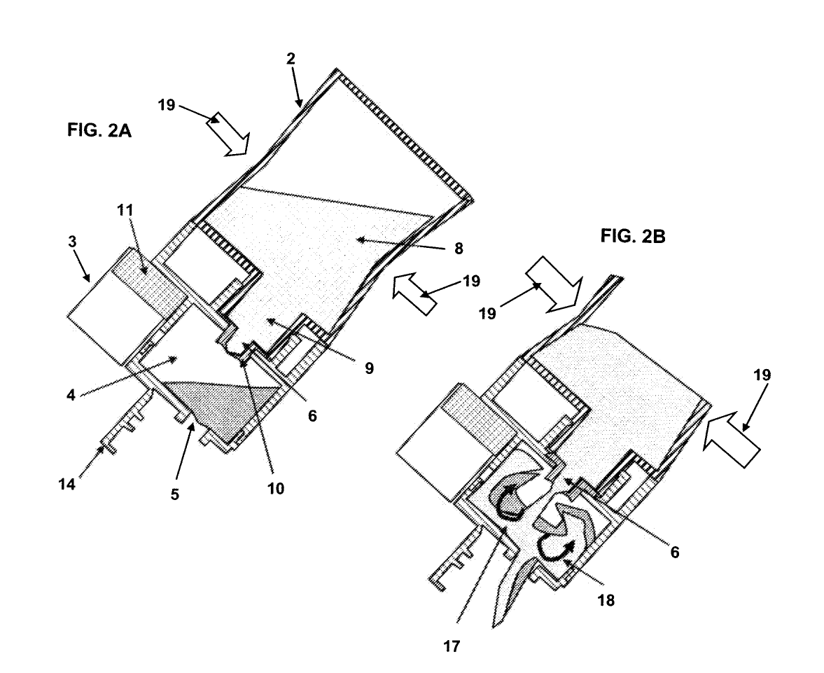

A second liquid 11 can be dispensed into the mixing chamber 4 through the second inlet opening 7. In the apparatus 1 resting position as depicted in FIG. 1, the second liquid 11 is separate from the first liquid 8, which is situated in the first container 2. As depicted in FIGS. 2A-B, in order to mix and dispense the first liquid 8 and the second liquid 11, the apparatus 1 is tilted and the first container 2 squeezed 19 by the user such that the first liquid 8 flows through the first container opening 9, into the first inlet opening 6, through the first one-way valve 10 and into the mixing chamber 4, where it can mix with the second liquid 11 and then the first liquid 8, and the second liquid 11 flow out of the outlet orifice 5. Following dispensing of a desired volume of liquid, the apparatus 1 is returned to the resting position by the user. During the operation of returning the apparatus 1 to the resting position, as the apparatus 1 is tilted closer to the resting position, the first one-way valve 10 prevents any volume of the first liquid 8 or the second liquid 11 from flowing into the first container 2.

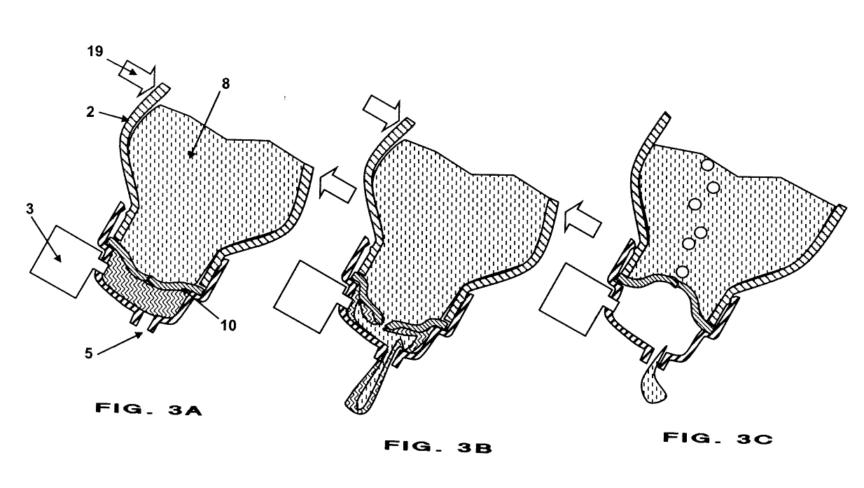

A preferred valve arrangement is depicted in FIGS. 3A-C. As can be seen in FIG. 3A, the user tilts the apparatus 1, and then squeezes 19 the first container 2. This forces the first liquid through the first one-way valve 10 into the mixing chamber 4. As the first liquid 8 is forced through the first one-way valve 10, it causes the first one-way valve 10 to deform into the mixing chamber 4 where it decreases the internal volume of the mixing chamber 4 (FIG. 3B). When a desired volume of liquid has been dispensed, the user ceases to squeeze the first container 2, the first one-way valve 10 then returns to its original configuration returning the mixing chamber 4 to its original volume (FIG. 3C).

### Mode of Operation

Another aspect of the present invention is a method for mixing and dispensing a first liquid 8 and a second liquid 11 from the apparatus 1 comprising the steps of;
Dispensing a second liquid 11 from the second container 3 through the second inlet opening 7, into the mixing chamber 4;
Tilting the apparatus 1 at an angle such that the first liquid 8 flows from the first container 2 into the first container opening 9;
Squeezing 19 the first container 2 such that the first liquid 8 is squeezed through the first one-way valve 10 into the mixing chamber 4 wherein the first liquid 8 mixes with the second liquid 11 in the mixing chamber 4;
Continuing to squeeze the first container 2, and maintaining the tilting angle such that, a desired volume of the first liquid 8 and/or the second liquid 11 is dispensed out of the outlet orifice 5;
Ceasing to squeeze the first container 2 and also decreasing the tilting angle to prevent any further liquid from being dispensed from the apparatus 1;
Further decreasing the tilting angle to return the apparatus 1 to the resting position.

It would be obvious to those skilled in the art what tilting angle is necessary, in order to achieve the desired effect of mixing and dispensing the first liquid 8 and the second liquid 11.

### Kit for Use

In one embodiment, the present invention provides a kit comprising, an apparatus 1 comprising, a first container 2, a second container 3 and a mixing chamber 4. The first container 2 and the second container 3 are removable. The first container 2 is resiliently deformable, contains a first liquid 8, and also a first container opening 9.

The mixing chamber 4 comprises walls and an outlet orifice 5. A first wall of the mixing chamber 4 comprises a first inlet opening 6, a second wall 16 of the mixing chamber 4 positioned opposite the first wall 15 comprises a liquid deflection zone 17. The first wall forms the base of the mixing chamber 4, and the mixing chamber 4 further comprises a second inlet opening 7. The first inlet opening 6 of the mixing chamber comprises a first one-way valve 10. The second container 3 contains a second liquid 11, and a second container opening 12. The second container opening 12 also comprises a second one-way valve 13.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An apparatus for mixing and dispensing liquids, comprising a first container, a second container and a mixing chamber, wherein;
the mixing chamber comprises walls and an outlet orifice;
wherein a first wall of the mixing chamber comprises a first inlet opening, a second wall of the mixing chamber positioned opposite the first wall comprises a liquid deflection zone;
and the first wall forms the base of the mixing chamber;
and the mixing chamber further comprises a second inlet opening;
the first container is resiliently deformable, contains a first liquid, and also a first container opening, the first container opening communicating with the first inlet opening of the mixing chamber;
and the first inlet opening of the mixing chamber comprises a first one-way valve;
the second container contains a second liquid, and a second container opening which communicates with the second inlet opening of the mixing chamber;
and wherein the second container opening comprises a second one-way valve;
and wherein, the liquid deflection zone is positioned directly opposite the first inlet opening.

2. The apparatus of claim 1, wherein the outlet orifice is positioned so that it is not opposite the first inlet opening.

3. The apparatus of claim 1, wherein the first container is removable.

4. The apparatus of claim 1, wherein the second container is removable.

5. The apparatus of claim 1, comprising third and fourth inlet openings.

6. The apparatus of claim 1, wherein the apparatus further comprises at least a third container comprising a third opening and a fourth container comprising a fourth opening.

7. The apparatus of claim 6, wherein the additional containers are removable.

8. The apparatus of claim 1, wherein the outlet orifice comprises a one-way valve.

9. A method for mixing and dispensing a first liquid and a second liquid from the apparatus according to claim 1, comprising the steps of;
Dispensing a second liquid from the second container through the second inlet opening, into the mixing chamber;
Tilting the apparatus at an angle such that the first liquid flows from the first container into the first container opening;
Squeezing the first container such that the first liquid is squeezed through the first one-way valve into the mixing chamber wherein the first liquid mixes with the second liquid in the mixing chamber;
Continuing to squeeze the first container, and maintaining the tilting angle such that, a desired volume of the first liquid and/or the second liquid is dispensed out of the outlet orifice;
Ceasing to squeeze the first container and also decreasing the tilting angle to prevent any further liquid from being dispensed from the apparatus;
Further decreasing the tilting angle to return the apparatus to the resting position.
